(19) United States
(12) Patent Application Publication
(10) Pub. No.: US 2004/0053132 A1
(43) Pub. Date: Mar. 18, 2004

(54) Improved fuel for a zinc-based fuel cell and regeneration thereof

(76) Inventors: Stuart I. Smedley, Escondido, CA (US); Guangwei Wu, Sunnyvale, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/660,942

(22) Filed: Sep. 12, 2003

Related U.S. Application Data
(60) Provisional application No. 60/410,569, filed on Sep. 12, 2002.

(51) Int. Cl. H01M 4/42; H01M 4/62; H01M 4/29

(52) U.S. Cl. 429/229; 429/232; 429/27; 429/29; 252/182.1; 205/64

(57) ABSTRACT

Improved fuel compositions have improved flow properties for use in zinc/air (oxygen) fuel cell systems. In some embodiments, an improved fuel composition comprises a collection of particles having zinc and at least one non-zinc metal having improved physical properties such as narrower particle size distributions and improved morphology. In one embodiment, the fuel composition comprising the improved collection of metal particles can be generated by applying an external EMF to a fuel regeneration solution. An improved regeneration solution can comprise an electrolyte, zincate ions and at least one non-zinc metal. Due to the presence of the non-zinc metal, and other additives, in the regeneration solution, the improved regeneration solution can be used to generate an improved fuel composition comprising a collection of particles having zinc and at least one non-zinc metal.

### CROSS REFERNCE TO RELATED APPLICATIONS

This application claims priority to U.S. Provisional Patent Application Serial Number 60/410,569, to Smedley et al. filed on Sep. 12, 2002, entitled “Electrolyte Composition For A Metal-Gas Electrochemical Cell,” incorporated herein by reference.

### FIELD OF THE INVENTION

This invention relates to fuel for metal based fuel cells, and especially to fuel compositions for regenerative zinc/air (oxygen) fuel cells. In particular, the invention relates to fuel compositions with improved physical properties. The invention further relates to compositions for generating a fuel for zinc/air (oxygen) fuel cells and methods for regenerating fuel compositions for zinc/air fuel cells.

### BACKGROUND OF THE INVENTION

In general, a fuel cell is an electrochemical device that can convert chemical energy stored in fuels such as hydrogen, zinc, aluminum and the like, into useful energy. A fuel cell generally comprises a negative electrode, a positive electrode, and a separator within an appropriate container. Fuel cells operate by utilizing chemical reactions that occur at each electrode. In general, electrons are generated at one electrode and flow through an external circuit to the other electrode where they are consumed. This flow of electrons creates an electrochemical potential difference between the two electrodes that can be used to drive useful work in the external circuit. For example, in one embodiment of a fuel cell employing metal, such as zinc, iron, lithium and/or aluminum, as a fuel and potassium hydroxide as the electrolyte, the oxidation of the metal to form an oxide or a hydroxide release electrons. In commercial embodiments, several fuel cells are usually arranged in series, or stacked, in order to create larger voltages. For commercially viable fuel cells, it is desirable to have electrodes that can function within desirable parameters for extended periods of time on the order of 1000 hours or greater.

A fuel cell is similar to a battery in that both generally have a positive electrode, a negative electrode and electrolytes. However, a fuel cell is different from a battery in the sense that the fuel in a fuel cell can be replaced without disassembling the cell to keep the cell operating. In some embodiments, a fuel cell can be coupled to, or contain, a fuel regeneration unit which can provide the fuel cell with regenerated fuels.

Fuel cells are a particularly attractive power supply because they can be efficient, environmentally safe and completely renewable. Metal/air fuel cells can be used for both stationary and mobile applications, such as all types of electric vehicles. Fuel cells offer advantages over internal combustion engines, such as zero emissions, lower maintenance costs and higher specific energies. Higher specific energies associated with selected fuels can result in weight reductions. In addition, fuel cells can give vehicle designers additional flexibility to distribute weight for optimizing vehicle dynamics.

### SUMMARY OF THE INVENTION

In a first aspect, the invention pertains to a solution for use in an electrochemical cell. In one embodiment, the solution can comprise an alkaline aqueous electrolyte, zincate ions, at least one non-zinc metal oxide. The solution can further comprise a zincate stabilizer, such as sodium silicate.

In a second aspect, the invention pertains to a collection of particles wherein the particles comprising zinc and at least one non-zinc metal. In one embodiment, the non-zinc metal can have a reduction potential equal to or more positive than the reduction potential of the zinc. In some embodiments, the collection of particles has an average size from about 0.1 mm to about 1.0 mm.

In another aspect, the invention pertains to an electrochemical cell comprising an anode, a gas diffusion electrode and a separator between the anode and the gas diffusion electrode. In one embodiment, the anode comprises a collection of metal particles and an electrolyte in a flowable slurry, wherein the metal particles comprise zinc and at least one non-zinc metal. In some embodiments, the gas diffusion electrode can comprise a catalyst for catalyzing the reduction of a gaseous oxidizing agent.

In a further aspect, the invention pertains to a method of replenishing the fuel for a metal/air fuel cell, the method comprising providing a collection of particles comprising zinc and at least one non-zinc metal, the non-zinc metal having a reduction potential equal to or more positive than the reduction potential of the zinc. In one embodiment, the collection of particles can have an average size from about 0.1 mm to about 1.0 mm.

In addition, the invention pertains to a method for electrolytically generating zinc particles from a solution comprising oxidized zinc, the method comprising generating zinc particles from a solution by applying a sufficient voltage to the solution such that oxidized zinc is reduced to zinc particles. In one embodiment, the solution comprises an electrolyte, oxidized zinc, at least one non-zinc metal oxide and sodium silicate.

### BRIEF DESCRIPTION OF THE FIGURES

FIG. 1 is a schematic diagram of a metal-air fuel cell designed for the continuous replenishment of metal fuel, in which a sectional side view of an anode is shown in phantom lines.

FIG. 2 is a sectional side view of the fuel cell of FIG. 1 showing a cathode, in which the section is taken along line 2-2 of FIG. 1.

FIG. 3 is a side view of a regeneration unit, in which an exterior case is made transparent to show an anode and a cathode.

FIG. 4 is a graph showing flow rates vs. time for a single cell tested with regenerated zinc pellets.

FIG. 5 is a graph showing power and pressure as a function of time for a cut wire baseline (CWB), zinc-indium composites, cut wire (CW) and zinc-bismuth composites over a single cell discharge.

FIG. 6 is a graph of corrosion rate and H₂ volume as a function of time for a cut wire zinc anode in electrolyte at 70° C.

FIG. 7 is graph of corrosion rate and H₂ volume as a function of time for cut wire zinc and a zinc alloyed with 0.01% Bi (obtained from Tech Cominco) in electrolyte containing 45 wt % KOH+2 wt % sodium silicate and 0.005 wt % poly (vinyl pyrrolidone).

### DETAILED DESCRIPTION OF THE INVENTION

Improved fuel compositions have improved flow properties for use in zinc/air (oxygen) fuel cell systems. In some embodiments, an improved fuel composition comprises a collection of particles having zinc and at least one non-zinc metal having improved physical properties such as narrower particle size distributions, improved morphology and lower corrosion rates. In one embodiment, the fuel composition comprising the improved collection of metal particles can be generated by applying an external EMF to a fuel regeneration solution. An improved regeneration solution can comprise an electrolyte, zincate ions and at least one non-zinc metal. Due to the presence of the non-zinc metal, and other additives, in the regeneration solution, the improved regeneration solution can be used to generate an improved fuel composition comprising a collection of particles having zinc and at least one non-zinc metal.

A metal based fuel cell is a fuel cell that uses a metal, such as zinc particles, as fuel in the anode. In a metal fuel cell, the fuel is generally stored, transported and used in the presence of a reaction medium, such as potassium hydroxide solution. The zinc metal is generally in the form of particles to allow for sufficient flow of the zinc fuel through the fuel cell. Specifically, in metal/air batteries and metal/air fuel cells, oxygen is reduced at the cathode, and metal is oxidized at the anode. In some embodiments, oxygen is supplied as air. For convenience, air and oxygen are used interchangeably throughout unless a specific context requires a more specific interpretation. In some embodiments, the fuel compositions may further include additional additives, such as stabilizers and/or discharge enhancers.

In general, gas diffusion electrodes are suitable for catalyzing the reduction of oxygen at a cathode of a metal fuel cell or battery. In some embodiments, gas diffusion electrodes comprise an active layer associated with a backing layer. The active and backing layers of a gas diffusion electrode are porous to gasses such that gasses can penetrate through the backing layer and into the active layer. However, the backing layer of the electrode is generally sufficiently hydrophobic to prevent diffusion of the electrolyte solution into or through the backing layer. The active layer generally comprises catalyst particles for catalyzing the reduction of a gaseous oxidizing agent, electrically conductive particles such as, for example, conductive carbon and a polymeric binder. Gas diffusion electrodes suitable for use in metal/air fuel cells are generally described in co-pending application Ser. No. 10/364,768, filed on Feb. 11, 2003, titled “Fuel Cell Electrode Assembly,” and in co-pending application Ser. No. 10/288,392, filed on Nov. 5, 2002, titled “Gas Diffusion Electrodes,” which are hereby incorporated by reference.

In metal/air fuel cells that utilize zinc as the fuel, the following reaction takes place at the anodes:

Zn+4OH^{—}→Zn(OH)₄^{2—}+2e^{—} (1)

The two released electrons flow through a load to the cathode where the following reaction takes place:

$$\frac{1}{2} {O}_{2} + 2 {e}^{-} + {H}_{2} O \to 2 O {H}^{-} \qquad ( 2 )$$

The reaction product is the zincate ion, Zn(OH)₄ ^{2—}, which is soluble in the reaction solution KOH. The overall reaction which occurs in the cell cavities is the combination of the two reactions (1) and (2). This combined reaction can be expressed as follows:

$$Zn + 2 O {H}^{-} + \frac{1}{2} {O}_{2} + {H}_{2} O \to {Zn ( OH )}_{4}^{2 -} \qquad ( 3 )$$

Alternatively, the zincate ion, Zn(OH)^{2—}, can be allowed to precipitate to zinc oxide, ZnO, a second reaction product, in accordance with the following reaction:

Zn(OH)₄^{2—}→ZnO+H₂O+2OH^{—} (4)

In this case, the overall reaction which occurs in the cell cavities is the combination of the three reactions (1), (2), and (4). This overall reaction can be expressed as follows:

$$Zn + \frac{1}{2} {O}_{2} \to ZnO \qquad ( 5 )$$

Under ambient conditions, the reactions (4) or (5) yield an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

Under certain conditions, corrosion of the zinc fuel can occur. The simplified reaction pathway that leads to zinc corrosion is shown below:

Zn+H₂O→ZnO+H₂ (6)

As shown in equation (6), the reaction involves the reduction of water to yield gaseous hydrogen and the oxidation of metallic zinc to the Zn (II) ion. The corrosion of zinc can be undesirable because the hydrogen gas represents a safety hazard. Additionally, the chemical oxidation that occurs during corrosion, as opposed to electrochemical oxidation, can be a parasitic pathway that removes active zinc from the system without the generation of electricity. In the battery industry, this process is sometimes referred to as “self discharge,” and is generally avoided. Furthermore, the generation of hydrogen within the plumbing of a zinc regenerative fuel cell system can cause gas bubbles to accumulate in, for example, the pumps and other points where system operation may be impeded. The accumulation of gas bubbles in the pumps of the fuel cell can result in the pumps losing their prime. In other situations, the gas bubbles can act as flow blockers or generate dead spots where there is substantially no electrolyte in the cells. Thus, it is generally desirable to reduce the corrosion of zinc and the generation of hydrogen gas within a metal/air fuel cell.

The corrosion of zinc can be controlled through the use of various additives incorporated in the metal as an alloying element, in the electrolyte, or both. While not wanting to be limited by a particular theory, it is believed that these additives function to increase the hydrogen overpotential. Possible additives to the electrolyte include, for example, organic additives such as sorbitol and polyethylene glycols. Suitable inorganic electrolyte additives include, for example, the oxides of bismuth, lead, tin, indium and mercury. Alloy additives can include, for example, indium, calcium, lead, bismuth, aluminum, manganese, magnesium, thalium and tin. For a further discussion of potential mechanisms, as well as additives commonly employed, the reader is referred to X. G. Zhang, “Corrosion and Electrochemistry of Zinc,” Plenum Press, New York, 1996, which is hereby incorporated by reference.

The improved fuel compositions of the present disclosure comprise a collection of particles having zinc and at least one non-zinc metal. Generally, the non-zinc metal can be present in concentrations from about 50 ppm by weight to about 10,000 ppm by weight relative to the zinc particles, and in further embodiments from about 100 ppm to about 1000 ppm by weight. A person of ordinary skill in the art will recognize that additional ranges within these explicit ranges are contemplated and are within the present disclosure. As will be described further below, the improved collection of metal particles can have desirable physical properties, such as, for example, durability, average particle size and shape, that make the collection of particles particularly useful in, for example, fuel cell applications. Additionally, the collection of particles can be consumed and repeatedly regenerated without significant loss, or degradation, of the improved physical properties. Thus, the improved fuel compositions are suitable for applications such as regenerative fuel cells.

In some embodiments, the present disclosure relates to regeneration solutions suitable for generating an improved collection of particles comprising zinc and at least one non-zinc metal. In one embodiment, the regeneration solution comprises an electrolyte, zincate ions and ions of at least one non-zinc metal. In some embodiments, the regeneration solution may further comprise additional additives such as, for example, stabilizers and discharge extenders. Due to the presence of the non-zinc metal and other additives, the regeneration solution can be used to generate a collection of particles comprising zinc and at least one non-zinc metal with improved physical properties. In one embodiment, the regeneration solution may be formed in a zinc/air (oxygen) fuel cell by the oxidation of zinc fuel to zincate ions. The regeneration solution can be provided to a regeneration unit, which may be a part of a zinc/air (oxygen) fuel cell system or separate such that the regeneration solution is transported to the regeneration unit.

In one embodiment, an improved fuel composition can be produced in a regeneration unit that operates by electrolysis. As will be described below, a regeneration solution can be provided to a suitable regeneration unit where an external electric potential can be applied to the solution. The external electric potential can reduce the zincate ions to zinc particles, which can then be collected and used as fuel for a zinc/air (oxygen) fuel cell. The presence of the non-zinc metal ions, as well as regeneration conditions such as, for example, current density, charge density, electrolyte flow rate and temperature, can influence the properties of the collection of particles generated in the regeneration unit. The generated collection of particles can be provided to a generated fuel storage container and/or directly to the anode of a zinc/air (oxygen) fuel cell.

In particular, the improved fuels are particularly useful in fuel cell applications because the collection of particles can have improved durability as a result of reduced corrosion during inactive storage in comparison with compared to other collections of particles. Also, the particles have improved mechanical stability such that the particles are not significantly fragmented by the pumping action of the fuel cell even after thousands of cycles through the cell. Additionally, the average particle size and shape of the collection of particles provides the fuel compositions with improved conductivity, density and viscosity. Furthermore, the morphology of the collection of particles helps prevent the particles from clogging the pumps and piping systems of the fuel cell as the particles are circulated through the cell.

Structure of a Metal/Air Fuel Cell System

A metal/air fuel cell involves oxidation of metal at the anode and reduction of oxygen at the cathode. The metal can be replenished such that the cell can continue to function indefinitely. Thus, the fuel cell system comprises a metal delivery section that can be operably connected with the fuel cell. The fuel cell unit comprises at least one anode and cathode spaced apart with a separator, which are all in contact with an electrolyte, such as concentrated potassium hydroxide. Generally, the fuel cell unit is in a housing that provides for appropriate air-flow, maintenance of the electrolyte, connection with the metal delivery section and electrical contact to provide electrical work.

In some embodiments, the metal/air fuel cell system further comprises a regeneration unit, which can reprocess the above noted reaction products to yield oxygen and zinc particles. In general, the reaction product Zn(OH)₄^{2—} and/or possibly ZnO or other zinc compounds, can be reprocessed with the application of an external electric potential, for example, from line voltage, to yield oxygen and zinc particles. The regenerated zinc particles can optionally be stored in a fuel storage unit, and similarly the reaction products can be stored in a reaction product storage container. In some embodiments, the fuel storage unit can be operably coupled to the fuel cells in order to supply the regenerated fuel to the electrodes. The regeneration unit may or may not be in physical proximity with the fuel cell.

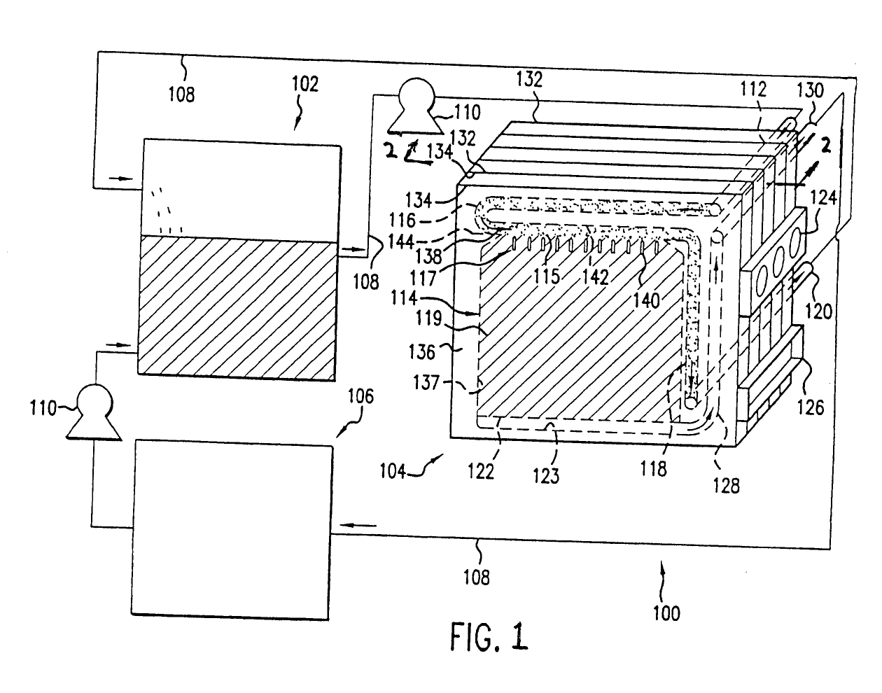

A particular embodiment of a zinc-air fuel cell system 100 is shown in FIG. 1. The zinc-air fuel system 100 comprises a zinc fuel tank 102, a zinc-air fuel cell stack or power source 104, an electrolyte management unit 106, a piping system 108, one or more pumps 110, and one or more valves (not shown) that define a closed flow circuit for the circulation of zinc particles and electrolyte during fuel cell operation. The zinc fuel tank 102, the electrolyte management unit 106, or a combination of these and/or other system components, may be a separable, detachable part of the system 100.

Zinc pellets in a flow medium, such as concentrated potassium hydroxide (KOH) electrolyte solution, are located in the zinc fuel tank 102. In another implementation, the particles can be a type of metal other than zinc, such as aluminum (aluminum-air fuel cell), lithium (lithium-air fuel cell), iron (iron-air fuel cell), or a particulate material other than metal that can act as an oxidant or reductant. In other embodiments, the flow medium is a fluid, e.g., liquid or gas, other than an electrolyte. The zinc and electrolyte solution can be, for example, pulsed, intermittently fed, or continuously fed from the zinc fuel tank 102, through the piping system 108, and into an inlet manifold 112 of the cell stack 104. Piping system 108 can comprise one or more fluid connecting devices, e.g., tubes, conduits, elbows, and the like, for connecting the components of system 100.

Power source 104 comprises a stack of one or more bipolar cells 114, each generally defining a plane and coupled together in series. Each cell 114 has an open circuit voltage determined by the reduction and oxidation reactants within the cell along with the cell structure, which can be expressed as M volts. Assuming that the open circuit potential of all the cells are equal, power source 104 has an open-circuit potential P equal to M volts x N cells, where N is the number of cells in power source 104.

Zinc-air fuel cell 114 interfaces with a fuel cell frame or body 136. The fuel cell body 136 generally forms a fuel cell cavity 137. Each cell 114 includes an air positive electrode or cathode 132 that occupies can entire surface or side of cell 114 and a zinc negative electrode or anode 134 that occupies an opposite entire side of cell 114. The cathode and anode are separated by an electrically insulating separator. A porous and electrically conductive film may be inserted between the electrodes 132, 134 of adjacent cells such that air can be blown through the film for supplying oxygen to each air positive electrode 132.

The bipolar stack 104 may be created by simply stacking cells 114 such that the current collector of negative electrode 134 of each cell is in physical contact with the positive electrode surface 132 of adjacent cell 114, with the porous and electrically conductive substance there between. With this structure, the resulting series connection provides a total open circuit potential between the first negative electrode 134 and the last positive electrode 132 of P volts. With these structures, extremely compact high voltage bipolar stacks 104 can be constructed. Furthermore, since no wires are used between cells 114 and since electrodes 132, 134 comprise large surface areas, the internal resistance between cells is extremely low.

The interface between one positive electrode 132 and piping system 108 through inlet manifold 112 is shown in phantom lines in FIG. 1. Inlet manifold 112 can run through cells 114 of power source 104, for example, perpendicular to the planes defined by the cells. Inlet manifold 112 distributes fluidized zinc pellets to cells 114 via conduits or cell filling tubes 116. Each inlet conduit 116 lies within its respective cell 114.

The zinc particulates and electrolyte flow through a flow path 115 in each cell 114, generally within the plane of the cell. The method of delivering particles to the cells 114 is a flow-through method. A dilute stream of pellets in flowing KOH electrolyte is delivered to the flow path 115 at the top of the cell 114 via conduit 116. The stream flows through flow path 115, across the zinc particle bed, and exits on the opposite side of cell 114 via outlet tube 118. Some of the pellets in the stream are directed by baffles 140 into electroactive zone 119. Pellets that remain in the flow stream are removed from cell 114. This flow through method, along with baffles 140, allows the electroactive zone 119 to occupy substantially all of the cell cavity and remain substantially constantly filled with zinc particles. As a result, the electrochemical potential of each cell 114 is maintained at desired levels per cell cavity volume. Pumps 110 can be used to control the flow rate of electrolyte and zinc through system 110. The fuel cell cavity communicates with inlet manifold 112 via cell filling tube 116.

As the zinc particles dissolve in electroactive zone 119 of cell 114, a soluble zinc reaction product, zincate, is produced. The zincate passes through a screen mesh or filter 122 near a bottom 123 of cell 114 and is washed out of the active area of cell 114 with electrolyte that also flows through cell 114 and filter 122. Screen mesh or filter 122 causes the electrolyte that exits cell 114 to have larger zinc particles removed. The flow of electrolyte through cell 114 not only removes the soluble zinc reaction product and, thereby, reduces precipitation of discharge products in the electrochemical zone 119, it also removes unwanted heat, helping to prevent cell 114 from overheating.

Electrolyte exits cell 114 and cell stack 104 via an electrolyte outlet conduit 128 and electrolyte manifold 130, respectively. The electrolyte is drawn into electrolyte management unit 106 through piping system 108. A pump (not shown) may be used to draw electrolyte into the electrolyte management unit 106. Electrolyte management unit 306 can be used to remove zincate and/or heat from the electrolyte so that the same electrolyte can be added to the zinc fuel tank 102 for zinc fluidation purposes. Electrolyte management unit 106, like zinc fuel tank 102, may be part of an integral assembly with the rest of system 100, or it may be a separate, detachable part of system 100.

A constant supply of oxygen is required for the electrochemical reaction in each cell 114. To effectuate the flow of oxygen, one embodiment of system 100 can include a plurality of air blowers 124 and an air outlet 126 on the side of cell stack 104 to supply a flow of air comprising oxygen to the positive air electrodes/cathodes of each cell 114. A porous substrate such as a nickel foam may be disposed between each cell 114 to allow the air to reach the air cathode of each cell and to flow through the stack 104. In other embodiments, an oxidant other than air, such as pure oxygen, bromine or hydrogen peroxide, can be supplied to a cell 114 for the electrochemical reaction.

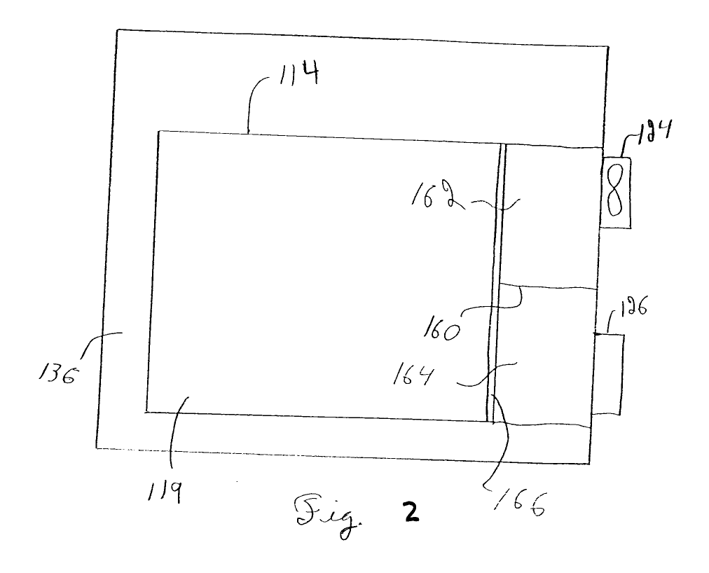

A sectional view of system 100 in FIG. 2 displays a positive air electrode/cathode 132 within one cell 114 of cell stack 104. Positive air electrode 132 is held with cell 114 within fuel cell frame 136. A non-porous divider 160 separates gas inflow from air blowers 124 from air outlets 126. Frame 136 forms an inlet chamber 162 and an outlet chamber 164. Inlet chamber 162 and outlet chamber 164, respectively, form passageways from positive air electrode 132 to air blowers 124 and air outlets 126. A gas permeable membrane 166 can be placed between air chambers 162, 164 and electrode 132 to reduce or prevent loss of electrolyte through flow out of the cell and/or evaporation.

While certain configurations of the positive air electrode/cathode are suitable for use in the fuel cell of FIG. 1, a broader range of gas diffusion electrode structures are generally useful and are described further below.

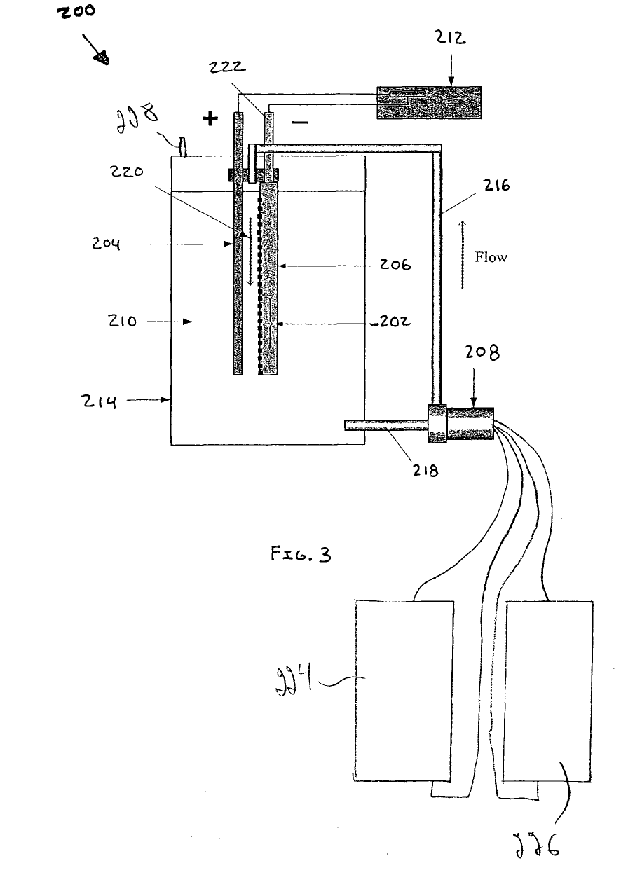

Referring to FIG. 3, an embodiment of a regeneration unit is shown. In this embodiment, regeneration unit 200 comprises an anode 204, a cathode 206, a pump 208, a power supply 212, and container 214. Regeneration unit 200 can be configured to produce metal particles by electrolysis of a regeneration solution 210 that contains dissolved metal. In some embodiments, anode 204 and cathode 206 can be electrodes which are at least partially immersed in solution 210. Generally, anode 204 and cathode 206 are aligned parallel to each other in container 214 such that adjacent surfaces of anode 204 and cathode 206 define a space where the regeneration reactions can occur. Container 214 generally holds regeneration solution 210 as well as anode 204 and cathode 206. Solution 210 generally is aqueous, although organic solvents, such as alcohols, can be substituted for an aqueous solvent. In one embodiment, solution 210 can be a regeneration solution comprising zincate ions, Zn(OH)₄^{2—}, or dissolved/dispersed ZnO. The zincate ions can be produced by the above mentioned electrochemical reactions which, in one embodiment, can occur in a zinc/air (oxygen) cell. Suitable regeneration solutions and methods for forming regenerations solutions are further described below. In alternative embodiments, a regeneration unit can comprise a plurality of electrode pairs, which can be connected in parallel or in series.

System 200 can produce metal particles, for example, zinc particles, through electrolysis, which in one embodiment occurs in the space between a surface of anode 204 and the opposing surface of cathode 206. During operation, anode 204 and cathode 206 can be coupled, respectively, to the positive and negative terminals of power supply 212. In some embodiments, a pump 208 can be provided to circulate solution 210 into and out of container 214. In general, pump 208 can be any mechanical device capable of circulating fluids. In one embodiment, as shown in FIG. 3, solution 210 can flow into container 214 through conduit 216, and can flow out of container 214 through conduit 218. Generally, by pumping solution 210 into and out of container 214 a flow path 220 can be created along the surface of cathode 206.

Cathode 206 can comprise on its surface a plurality of active zones 202 that are exposed to solution 210 flowing along flow path 220. In one embodiment, as pump 208 circulates solution 210 to flow past active zone 202, metal particles can be formed on active zone 202 by electrolysis. Once formed, the metal particles may be removed form active zones 202 by a scraper or other suitable means. In some embodiments, the scraper is a stationary edge that contacts the cathode as the cathode is moved from one position to another position to apply the scraping function. In other embodiments, the cathode can be cylindrical in shape with a cylindrical anode surrounding the cathode. The scraper can be an edge that contacts the cathode surface upon rotation of the cathode relative to the anode. In a further embodiment, the cathode and anode are stationary plates and the scraper rotates to scrape the surface of the cathode. The scraper may or may not be in contact with the cathode.

In some embodiments, active zones 202 can comprise a conductive material electrically, such as a surface coating, coupled to conductor 222 within cathode 206. Active zones 102 may be formed of a material with easy release surface properties to facilitate removal of the metal particles. This easy release property can be imparted by applying a coating or through the oxidation of the surface. Metals having oxides with sufficient electrical conductivity include, for example, magnesium, nickel, chromium, niobium, tungsten, titanium, zirconium, vanadium and molybdenum. For example, the active zones can be formed from a plurality of metal layers with the top layer being oxidized. Generally, active zones 202 can be electrically isolated from one another at the cathode surface by an insulator. The active zones can be organized into an array separated by the insulator. In some embodiments, the insulator may be, for example, non-conductive metal oxides or a polymer film such as, for example, polyethylene, polypropylene, an epoxy polymer, or blends, derivatives and/or copolymers thereof. The design of the conductor, insulator and active zone may be guided by the particular application of the cathode. For example, the surface of the cathode may be flat or curved, and have a general shape that can be planar, cylindrical, spherical or any combination thereof. In some embodiments, the cathode may have a single surface with active zones, while in other embodiments the cathode may have multiple surfaces with active zones. Generally, the size and number of the active zones on the surface of the cathode influence the size and number of metal particles that the system can produce in a single operation.

An individual active zone may have a flat or curved surface. Furthermore, an individual active zone may assume any regular geometric shape, or may have an irregular shape. The active zones, considered collectively, may comprise multiple shapes, sizes and placement patterns, and may be formed form the conductor, or may be separate components connected thereto.

The product metal particles may be harvested from the solution through the flow of the electrolyte regeneration solution from the unit out of an exit conduit or through a specific hopper that collects particles through the force of gravity and removed through a fluid flow in a concentrated suspension from the collection of particles in the hopper. In some embodiments, the metal particles can be transferred to fuel storage container 224, while in other embodiments the metal particles can be provided directly to the anode of a metal/air fuel cell 226. In further embodiments, different portions of the metal particles may be directed separately to fuel storage container 224 and the anode of the fuel cell 226. Various connections and corresponding flow patterns can be established between the regeneration unit and a fuel cell and/or a storage container, as well as a plurality of storage containers and/or fuel cells.

In addition to producing zinc particles, oxygen gas is generally also produced in the regeneration unit. In some embodiments, the oxygen gas can be vented through vent 228. One of ordinary skill in the art will recognize that numerous variations in regeneration unit design exist and are within the scope of the present invention.

Suitable regeneration unit designs are discussed in more detail in copending U.S. application Ser. No. 10/424,539 to Smedley et al. filed on Apr. 24, 2003, entitled “Discrete Particle Electrolyzer Cathode And Method Of Making Same,” incorporated herein by reference.

Fuel Compositions And Regeneration Solutions

Improved zinc-based fuel compositions have desirable properties of the zinc particles, and improved regeneration solutions provide for the formation of the improved zinc-based fuel compositions. In some embodiments, the regeneration solution comprises a solution having an electrolyte, zincate ions, and at least one non-zinc metal oxide or metal hydroxide corrosion inhibitor. In some embodiments, a fuel composition comprises a collection of particles having zinc and at least one non-zinc metal corrosion inhibitor. In these embodiments, the collection of particles comprising zinc and at least one non-zinc metal can have improved physical properties such as, for example, corrosion resistance, average particles size, particle size distributions, morphology, geometry, density and fragmentation resistance, which makes the collection of particles particularly suitable for use in, for example, fuel cell applications. In some embodiments, the fuel compositions, the regeneration solutions, or both, can further comprise additives such as, for example, stabilizers and discharge extenders that improve the performance of the fuel composition in generating current.

The fuel regeneration solution can be used in the regeneration process described below to form zinc-based fuel cell fuel. In one embodiment, the zincate and/or zinc oxide can be formed in a fuel cell by the oxidation of zinc particles, however, other methods of forming zincate ions are possible. One of ordinary skill in the art will recognize that no particular method of generating zincate ions is required by the present disclosure. As will be describe below, in embodiments where the zincate ions are formed in a fuel cell by an oxidation reaction, any zinc particles can be used that have suitable size and shape to function in a metal/air fuel cell for the first discharge cycle, and that also contain desired additives for regeneration. Since all of the zinc is generally not consumed by the fuel cell, the properties of the zinc-based fuel may require several cycles through the fuel cell and regeneration unit to reach steady state properties.

The fuel regeneration solution generally also comprises at least one non-zinc metal oxide corrosion inhibitor. As described above, the corrosion inhibitor(s) generally prevent the formation of hydrogen gas. Suitable non-zinc metal oxide corrosion inhibitors include, for example, the oxides of Bi, Sn, Hg, Tl, and Pb, as well as In(OH)₃. Suitable corrosion inhibitors can be selected based on their ability to adsorb onto the surface of the zinc and based on having a high overpotential for hydrogen evolution. In some embodiments, the non-zinc metal oxide can be partially soluble in the electrolyte, while in other embodiments the non-zinc metal oxide may be substantially soluble in the electrolyte. Generally, the corrosion inhibitors have a higher overpotential for hydrogen evolution relative to elemental zinc. As will be described further below, the presence of the non-zinc metal oxide, and other additives, in the regeneration solution can improve the physical properties, i.e., size distribution and morphology, of a collection of particles generated from the regeneration solution.

In some embodiments, additional additives such as stabilizers and discharge extenders can also be included in the fuel composition solution. The stabilizer generally functions to stabilize the zincate ions. In one embodiment, the stabilizer can stabilize the zincate ion at concentrations up to about 3.5 M to about 5.2 M for cells operating at current densities up to about 360 mA/cm². In general, the stabilizer can be any chemical that is at least partially soluble in the electrolyte which can function to stabilize the zincate ions. Suitable stabilizers include, for example, silicate salts, such as sodium silicate and potassium silicate, lithium hydroxide, sorbitol, sodium metaborate, and combinations thereof. In some embodiments, the fuel composition also comprises discharge extenders, which can extend the discharge cycle of the fuel. In general, the discharge extender can be any chemical that is at least partially soluble in the electrolyte, extends the discharge cycle of the fuel, and does not interfere with the anode half reaction. Suitable discharge extenders include, for example, poly(vinyl pyrrolidone).

In some embodiments, the regeneration solution can comprise from about 0.5 percent to about 10 percent by weight sodium silicate, or other suitable stabilizers. In further embodiments, the regeneration solution can comprise from about 1 percent to about 4 percent by weight sodium silicate or other stabilizers. In embodiments employing a non-zinc metal oxide corrosion inhibitor, the non-zinc metal oxide can be present in some embodiments at a concentration of from about 50 ppm to about 1000 ppm by weight, and in further embodiments from about 100 ppm to about 500 ppm by weight. In some embodiments, more than one non-zinc metal oxide may be present. In these embodiments, the total concentration of non-zinc metal oxides, or hydroxides, can be from about 50 ppm to about 1000 ppm by weight. In embodiments where the regeneration solution comprises a discharge extender, the discharge extender can be present from about 100 ppm to about 1000 ppm by weight. Also, the regeneration solution generally comprises from about 0.3M to about 5.2M zincate ion, and in further embodiments from about 1M to about 4.5M zincate ion. One of ordinary skill in the art will recognize that additional ranges of concentrations of stabilizers, discharge extenders and non-zinc metal oxides within these explicit ranges are contemplated and are within the present disclosure.

In another embodiment of the present disclosure, a fuel composition is provided comprising a collection of particles having zinc and at least one non-zinc metal. The particles are generally suspended in a concentrated alkaline aqueous electrolyte. The alkaline electrolyte solution can comprise, for example, potassium hydroxide (KOH). In particular, the electrolyte can comprise at least about 20 weight percent KOH, and in further embodiments from about 30 weight percent to about 50 weight percent KOH dissolved in water. A person of ordinary skill in the art will recognize that additional ranges of KOH concentrations are contemplated and are within the present disclosure.

In some embodiments, the collection of particles can have an average particle diameter from about 0.1 mm to about 10 mm, and in other embodiments the collection of particles can have an average particle diameter from about 0.1 mm to about 1 mm, and in further embodiments from about 0.3 mm to about 0.7 mm. In some embodiments, the collection of particles can have a size distribution such that at least about 95 percent of the particles have a diameter greater than about 40 percent of the average diameter and less than about 160 percent of the average diameter. Diameter measurements on the particles are based upon an average of length measurements along the principal axes of the particle. Generally, the collection of particles can have a lower surface area for a given mass of zinc. In other words, the surface of the collection of particles can have reduced numbers of nodules, spikes, dendritic growths and the like. Additionally, the collection of particles can have a particle density at least about 5 g cm ⁻³, and in further embodiments at least about 5.5 g cm⁻³. A person of ordinary skill in the art will recognize that additional ranges of average diameters, particle size distributions and densities within the explicit ranges are contemplated and are within the present disclosure.

As described above, the collection of particles comprises at least one non-zinc metal. In some embodiments, the non-zinc metal can function as a zinc corrosion inhibitor. Suitable zinc corrosion inhibitors are described above. In some embodiments, the non-zinc metal can be present from about 50 ppm to about 10,000 ppm by weight, and in further embodiments from about 200 ppm to about 8000 ppm by weight, and in other embodiments from about 350 ppm to about 6500 ppm by weight. One of ordinary skill in the art will recognize that additional ranges of non-zinc metal concentrations within these explicit ranges are contemplated and are within the present disclosure. The presence of the corrosion inhibitor reduces the corrosion of the fuel, which can be especially significant during inactive storage of a fuel cell during which hydrogen may be generated as zinc corrodes.

A suitable collection of particles comprising zinc and at least one none zinc metal corrosion inhibitor for use in fuel cell applications have been obtained from Teck Cominco (Missegaugua, Canada). Additionally, as the collection of particles is repeatedly consumed and regenerated, the physical properties of the collection of particles can also improve. It is believed this is due to an increasing percentage of the original zinc particles being consumed and regenerated to the improved collection of particles.

In some embodiments, the collection of particles can be cylindrical, round, oblong or spherical in shape. Furthermore, the improved fuels generally comprise particles with a particularly good morphology. With respect to the good morphology of the particles, the particles have a high degree of smooth surfaces with few, if any, protrusions. The smooth particles have good packing properties, good flow and are resistant to fragmentation from collisions and other forces within a flow.

Furthermore, the improved fuels generally comprise zinc particles with spherical or oblong spherical shapes. In particular, generally at least about 95 percent of the particles have lengths along the three principle axes of the particles that are within a factor of three (greater or smaller) of the average particle diameter. In further embodiments, at least about 95 percent and in further embodiments at least about 99 percent of the particles have lengths along the three principle axes that are within a factor of two (greater or smaller) of the average particle diameter. A person of ordinary skill in the art will recognize that additional ranges quantifying particles spherical nature within the explicit ranges above are contemplated and are within the present disclosure.

Performing Regeneration

For performing regeneration, a suitable regeneration solution, as described above, can be provided to a regeneration unit. An external electric potential can be applied to the solution such that the zincate ions and the at least one non-zinc metal oxide or hydroxide can be reduced to a collection of particles comprising zinc and at least one non-zinc metal. As mentioned above, due to the combination of stabilizers and non-zinc metals, or non-zinc metal oxides, the regenerated collection of particles can have improved physical properties such as, for example, size distribution and durability. For example, referring to Tables 1 and 2 below, zinc particles or pellets generated with bismuth, or an oxide of bismuth, present do not fragment as easily as zinc particles generated in the absence of bismuth.

During the regeneration process, it may be desirable to control some of the processing parameters that can influence the properties of the resulting product particles. In particular, suitable parameters to control include, for example, the flow rate, temperature of the solution, the concentration of the dissolved metal compositions, the electrolyte concentration, Reynolds number of the flow past the cathode surface, the flow turbulence or lack thereof, the amperage of the electric current through the solution and the current density and charge density at the active zones of the cathode. These parameters can be controlled empirically to obtain desired particle properties. Control of these parameters is described further in copending U.S. patent application Ser. No. 10/424,571 to Smedley et al. filed on Apr. 24, 2003, entitled “Method Of Production Of Metal Particles Through Electrolysis,” incorporated herein by reference.

The collection of particles formed by regeneration can be provided to the anode of a zinc/air fuel cell such that the zinc can be oxidized to zincate ions, and the non-zinc metal can be oxidized to a non-zinc metal oxide or metal hydroxide, or remain in the metallic state. In some embodiments, the zincate ions and the non-zinc metal oxide or metal hydroxide can be transported, via an electrolyte, to a regeneration unit where the zincate ions and the non-zinc metal can be regenerated to form a collection of particles comprising zinc and at least one non-zinc metal. This regenerated collection of particles can optionally be provided to the anode of a zinc/air fuel cell, where the collection of particles can be oxidized to zincate ions and at least one non-zinc metal oxide or hydroxide. The zincate ions and the non-zinc metal oxide or hydroxide can again be provided to a regeneration unit where the zincate ions and the non-zinc metal can be converted into a collection of particles having desirable physical properties. Thus, the collection of particles of the present disclosure can be repeatedly regenerated to form a fuel with desirable physical properties. As a result, the collection of particles of the present disclosure is desirable for use in, for example, regenerative fuel cells.

In some embodiments, the fuel composition solution can be continuously circulated through the regeneration unit during regeneration, while in other embodiments the fuel composition solution can be periodically circulated through the regeneration unit. In some embodiments, the substantially all of the zincate ions can be regenerated to zinc particles, while in other embodiments only a portion of the zincate ions can be regenerated to zinc particles. Generally, the regenerated collection of particles can be transported to a fuel storage container, however, in some embodiments the regenerated collection of particles can be provided directly to the anode of a zinc/air fuel cell.

Generally, the physical properties of the collection of particles can be tailored or controlled by properties of the regeneration unit. For example, variation of the current density, electrolyte flow rate, temperature, cathode pin dimensions and separation, and composition of the electrolyte can change the physical properties of the collection of particles. For an electrolyzer with a cathode surface area of 10,000 square millimeters spaced 3 millimeters from the anode with 4900 active zones and an active zone diameter of 0.4 mm for an active zone area of 615.8 square millimeters, current densities of greater than about 7000 amps per square meter can be used to generate crystalline zinc particles over a wide range of zincate concentrations. Reasonable results could be obtained over a wide range of liquid electrolyte temperatures.

### EXAMPLES

To confirm that the regenerated collection of particles comprising zinc and at least one non-zinc metal have improved physical properties, experiments were conducted to: (1) determine the rate of Zn corrosion at 70° C.; (2) determine the extent of comminution of the pellets and the size distribution after cycling for several thousand cycles; (3) determining the electrodeposition of Zn as a function of zincate concentration; and (4) evaluate single cell runs with Zn pellets electrodeposited from electrolyte containing zincate and various additives.

Morphology

The morphology of electrolyzed Zn pellets was evaluated by a pump test. The testing device was a closed loop comprising a variable speed pump, a fluidization chamber, an in line heater and a pellet collection loop. The pellet fluidization was controlled by varying the pump speed. The pump test cycled the particles for 3,500 cycles, which lasted for two hours. The particles were removed form the test system, and subsequently washed with water and dried. The Zn particles were then sieved through a 250 μM sieve. The resulting fine particles were weighed to determine the fraction of the total particle weight that was below 250 μM. Table 1 show the results from a pump test conducted at 55° C. for pellets regenerated from electrolyte containing 400 ppm of Bi₂O₃.

TABLE 1
Results of the 2-hour pump test at 55° C. for Zn particles regenerated
at 240 A, 5 min deposition time and 55° C. from 45 wt % KOH + 2 wt %
Na silicate + zincate + 400 ppm Bi₂O₃

| | Total | | | |
|---|---|---|---|---|
| | Sample | Particle size | Particle size | % Particles |
| Regeneration | Weight-dry | >250 μm | <250 μm | below 250 |
| Time | (g) | (g) | (g) | μm |
| 3.5 | 56.73 | 49.05 | 7.47 | 13 |
| 7.0 | 62.40 | 49.26 | 12.96 | 21 |
| 10.5 | 68.86 | 60.54 | 8.70 | 13 |
| 14.0 | 70.42 | 60.00 | 9.60 | 14 |
| 17.5 | 74.66 | 68.00 | 6.33 | 8.5 |
| 21.0 | 82.77 | 70.86 | 10.62 | 13 |
| 24.5 | 67.90 | 60.53 | 7.65 | 11 |
| 28.0 | 59.80 | 45.20 | 14.41 | 24 |
| 31.5 | 35.00 | 23.40 | 12.00 | 34 |

Table 2 shows the results from a pump test conducted with Zn pellets regenerated without Bi₂O₃. As Tables 1 and 2 show, the pellets regenerated in the absence of Bi tend to break, or fragment, significantly more than pellets regenerated from electrolyte containing Bi.

TABLE 2
Results of the 2-hour pump test at 55° C. for Zn particles regenerated
at 240 A, 5 min deposition time and 55° C. from 45 wt % KOH + 2 wt %
Na silicate + zincate and no Bi₂O₃

| | Total | | | |
|---|---|---|---|---|
| | Sample | Particle size | Particle size | % Particles |
| Regeneration | Weight-dry | >250 μm | <250 μm | below 250 |
| Time | (g) | (g) | (g) | μm |
| 3.5 | 41.0 | 18.2 | 22.8 | 55 |
| 7.0 | 58.9 | 29.3 | 29.6 | 50 |
| 10.5 | 62.7 | 38.3 | 24.4 | 38.9 |
| 14.0 | 53.4 | 31.9 | 21.5 | 40 |
| 17.5 | 54.5 | 35 | 19.5 | 36 |
| 21.0 | 51.2 | 27.7 | 23.5 | 46 |
| 24.5 | 56.1 | 32.7 | 23.4 | 42 |
| 28.0 | 49.5 | 25.3 | 24.2 | 49 |
| 31.5 | 54.6 | 23.6 | 31 | 57 |

Quality of Regenerated Zn Pellets

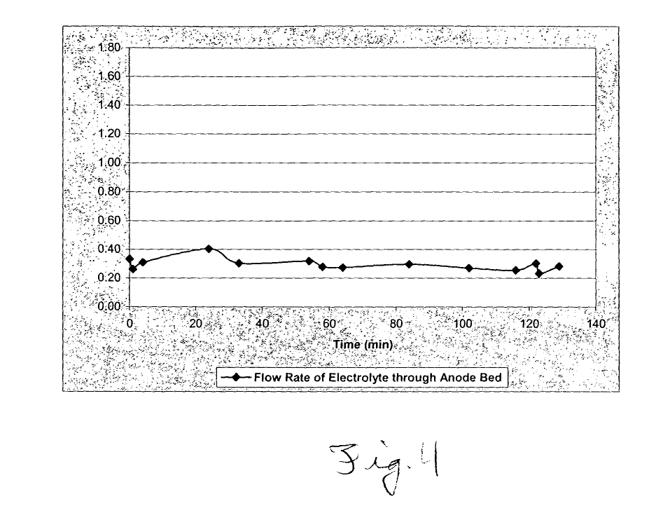

The hydraulic resistance of regenerated zinc pellets was examined by measuring the flow, in liters per minute (LPM), through the anode bed as a function of time. The duration of the experiment was about 129 minutes. As shown in FIG. 4, the average flow for the duration of the experiment was 0.25 LPM. For comparison, the flow for cells containing cut wire zinc (commercial zinc with a cylindrical shape) is also around 0.25 LPM. Thus confirming that an anode comprised of regenerated particles pass sufficient KOH to enable high current densities.

Discharge Cycles Using Zinc Alloys

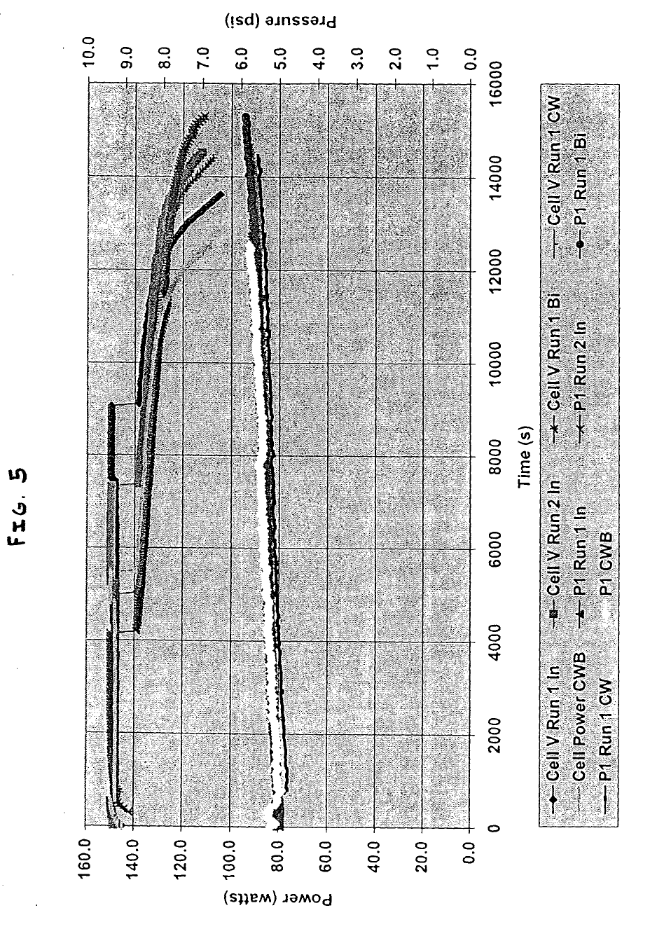

Zinc alloys of various compositions were used to discharge single cells. The alloys used were (1) zinc plus 1000 ppm of Bi; (2) zinc plus 1000 ppm of In; and (3) zinc plus 250 ppm of In. FIG. 5 shows the cell power v. time for discharge with the above mentioned zinc alloys and cut wire zinc for comparison. Initially, each cell was discharged at a constant power of 150 W to demonstrate that each fuel composition could deliver the power expected during normal product operation. After at least 4,000 seconds of constant power discharge, each fuel composition was discharged at a constant current of 150 A. As shown in FIG. 5, under the above mentioned conditions, the power of each cell drops slowly because of the decreasing electrolyte conductivity. However, the power delivered by each fuel composition is nearly identical.

Corrosion of Various Zinc Pellets

The rate of corrosion can be quantified by measuring the rate of hydrogen generation, which can be accomplished by using volume displacement. For example, a known mass of zinc can be added to a container with a graduated column attached. A test solution, i.e., the electrolyte, can then be added to container, which is subsequently sealed. The container, and attached graduated column, can be placed in a 70° C. temperature controlled bath/sample shaker, and the volume of hydrogen evolved can be monitored as a function of time. The volume of hydrogen generated, normalized to the mass of zinc used, can be plotted as a function of time. The rate of hydrogen evolution can then be calculated as the first derivative of hydrogen volume generated with respect to time. Using non-linear regression analysis, the hydrogen evolution rate can be plotted as a function of time and the curve can be fitted the function shown below:

R(t)=R_{∞}+R₀exp{−t/t₀} (7)

In equation (7), R(t) is the rate of hydrogen evolution as a function of time, R_{∞} is the steady state corrosion rate, (R_{∞}+R₀) is the corrosion rate at t=0, and t₀ is a time constant relating how long it takes the system to approach a steady state. Since the present disclosure is generally directed towards the long term storage of zinc particles, all corrosion rates expressed in the examples are R values.

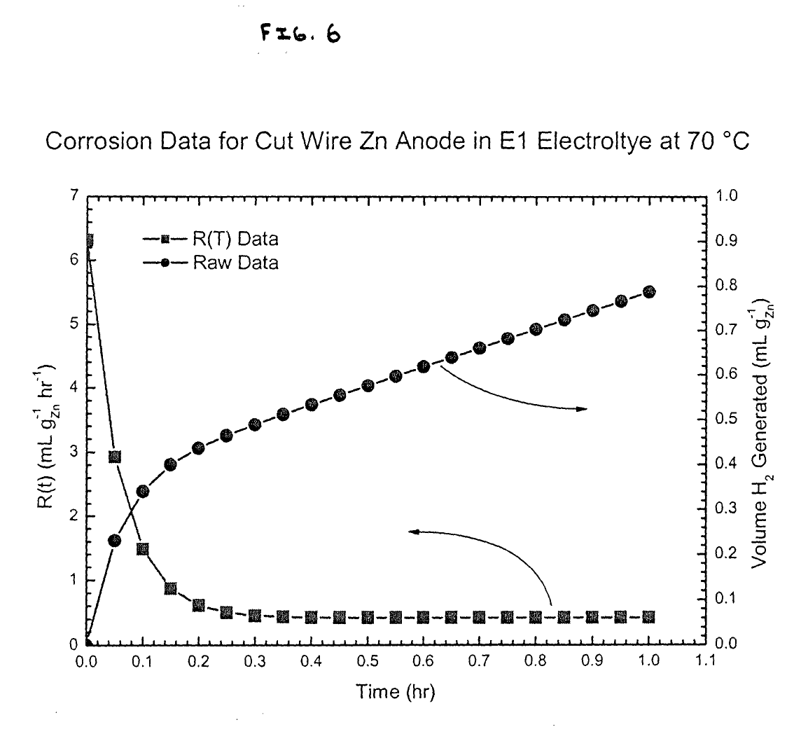

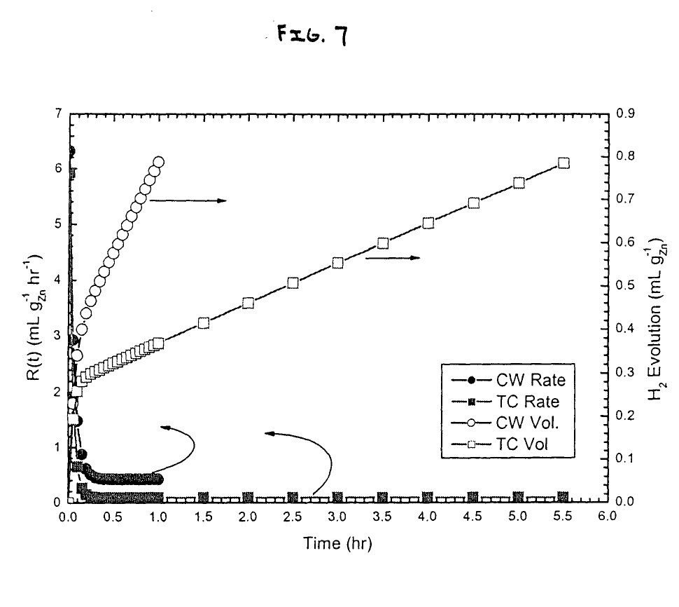

The corrosion data for cut wire zinc in electrolyte solution comprising 45% KOH, 2% sodium silicate and 0.005% poly(vinyl pyrrolidone) is shown in FIG. 6. The cut wire pellets have an average particle diameter of about 0.625 μm. The value of the steady state rate of hydrogen evolution (or R_{∞} value) was 0.42 (±0.04) ml g_{Zn}⁻¹ hr⁻¹. Other fuel composition were also studied, and the results are presented in Table 3. The data in table 3 is arranged by the type of zinc and the electrolyte employed. The last column in Table 3 is the R value normalized to the R value of the cut wire zinc. FIG. 7 shows the raw and R(t) data versus time for cut wire zinc and for Tech Cominco zinc containing 0.01% Bi. As shown in FIG. 7, the rate of hydrogen evolution is lower for the Tech Cominco sample with 0.01% Bi.

TABLE 3
Summary of corrosion rate data as measured at 70° C., and the
rate data relative to cut wire zinc in E1 Electrolyte

| | | R ∞ (mL g_{Zn}⁻¹ hr⁻¹) | | |
|---|---|---|---|---|
| Type of Zn | Electrolyte | Value | Error | Rᵣₑₗ* |
| Cut Wire | 45% KOH | 0.387 | 0.069 | 0.915 |
| Cut Wire | E0^{a} | 0.431 | 0.066 | 1.019 |
| Cut Wire | E1^{b} | 0.423 | 0.037 | 1.000 |
| Cut Wire | 3.5 M Zincate in E1 | 0.310 | 0.027 | 0.733 |
| Cut Wire | In(OH)₃ sat'd E1^{c} | Too slow to measure^{e} | | 0.000 |
| Cut Wire | Bi₂O₃ Sat'd E1^{d} | 0.243 | 0.045 | 0.574 |
| Cut Wire | In(OH)₃ + Bi₂O₃ sat'd E1 | Too slow to measure^{e} | | 0.000 |
| Cut Wire | Ni + E1 | Too Fast to Measure | | |
| Cut Wire | Brass + E1 | | | |
| Cut Wire | Cu + E1 | | | |
| Cut Wire | Sn Plated Ni + E1 | 0.593 | 0.137 | 1.403 |
| Cut Wire | Sn Plated Cu + E1 | 0.515 | 0.103 | 1.218 |
| Cut Wire | Sn Plated Brass + E1 | 0.480 | 0.051 | 1.136 |
| Cut Wire | Sn/Pb (60/40) Plated Brass + E1 | 0.457 | 0.028 | 1.082 |
| Cut Wire | Sn/Pb Plated Cu + E1 | 0.471 | 0.032 | 1.114 |
| X-15 Regen Pellets (1100 ppm Bi) | E1 | 0.472 | 0.056 | 1.118 |
| X-15 Regen Pellets (1100 ppm Bi) | 3.5 M Zincate in E1 | 0.159 | 0.054 | 0.377 |
| TechCominco 0.1% In | E1 | 0.130 | 0.023 | 0.308 |
| TechCominco 0.1% Bi 250-400 μm | E1 | 0.092 | 0.016 | 0.218 |
| Particles | | | | |
| TechCominco 0.1% Bi 400-600 μm | E1 | 0.073 | 0.014 | 0.172 |
| Particles | | | | |
| X-15 Regen Pellets (1100 ppm Bi) | Bi₂O₃ Sat'd E1 | 0.403 | 0.048 | 0.953 |
| Regen from 250 ppm In (OH)₃ | E0 | 0.613 | 0.089 | 1.450 |
| Electrolyte | | | | |
| X-15 Regen Pellets (1100 ppm Bi) | E0 | 0.412 | 0.017 | 0.975 |

^{a}E0 is 45% KOH + 2% Sodium Silicate;
^{b}E1 is EO +0.005% Poly(vinyl pyrrolidone);
^{c}In(OH)₃ sat'd E1 is E1 + 250 ppm In(OH)_{3;}
^{d}Bi₂O₃ saturated E1 is E1 + 80 ppm Bi₂O_{3;}
^{e}Too slow to measure in our experimental apparatus.

Referring to Table 3, several observations can be made regarding the data. First, the presence of In(OH)₃ in the electrolyte results in a lower rate of corrosion for cut wire pellets to a rate that is too low to measure in our system. The presence of Bi₂O₃ also slowed the corrosion rate, but not too the extent of the indium sample. Second, the table shows that particle size may be a factor, since the corrosion rates for the two Bi alloys were within experimental error of each other. Finally, the In salt in the electrolyte solution appears to have a larger impact on the corrosion rates than the In in the zinc alloy. Conversely, the Bi in the zinc alloy appears to have a greater impact on the corrosion rates than the Bi salt in the electrolyte. The table also shows that the presence of a high concentration of zincate ions also can have a mitigating effect on the rate of corrosion.

The embodiments above are intended to be illustrative and not limiting. Additional embodiments are within the claims. Although the present invention has been described with reference to particular embodiments, workers skilled in the art will recognize that changes may be made in form and detail without departing form the spirit and scope of the invention.

We claim:

1. A collection of particles wherein the particles comprise zinc and at least one non-zinc metal, the non-zinc metal having a reduction potential equal to or more positive than the reduction potential of the zinc, wherein the particles have an average diameter from about 0.1 mm to about 1 mm.

2. The collection of particles of claim 1 wherein the at least one non-zinc metal is present in a concentration of from about 50 parts per million to about 10,000 parts per million.

3. The collection of particles of claim 1 wherein the at least one non-zinc metal is present in a concentration from about 200 parts per million to about 800 parts per million.

4. The collection of particles of claim 1 wherein the particles have an average diameter from about 0.3 mm to about 0.7 mm.

5. The collection of particles of claim 1 wherein the particles have a size distribution wherein at least 95 percent of the particles have a diameter greater than about 40 percent of the average diameter and less than about 160 percent of the average diameter.

6. The collection of particles of claim 1 wherein the particles have a particle density of at least 5 g cm⁻³.

7. The collection of particles of claim 1 wherein the at least one non-zinc metal is selected from the group consisting of bismuth, indium, tin, lead, thallium, mercury, magnesium, manganese, aluminum and combinations thereof.

8. The collection of particles of claim 1 wherein at least about 95 percent of the particles have lengths along the three principle axes of the particles that are within a factor of three of the average particles diameter.

9. A fuel cell fuel comprising a collection of particles of claim 1 dispersed in an aqueous alkaline electrolyte.

10. A fuel cell fuel of claim 9 comprising from about 30 weight percent to about 50 weight percent KOH.

11. A fuel cell fuel of claim 9 further comprising a stabilizer selected from the group consisting of a silicate salt, lithium hydroxide, sorbatol, sodium metaborate and combinations thereof.

12. An electrochemical cell comprising:
an anode comprising a collection of metal particles of claim 1 and an electrolyte in a flowable dispersion;
a gas diffusion electrode comprising a catalyst for catalyzing the reduction of a gaseous oxidizing agent; and
a separator between the anode and the gas diffusion electrode.

13. A fuel cell system comprising an electrochemical cell of claim 12 and a regeneration unit connected to the electrical chemical cell wherein the regeneration unit is operably connected to the electrochemical cell to provide the electrochemical cell with a regenerated collection of particles.

14. A regeneration solution for use in a electrochemical cell, the solution comprising:
an alkaline aqueous electrolyte;
zincate ions; and
at least one non-zinc metal oxide or metal hydroxide.

15. The regeneration solution of claim 14 further comprising a zincate stabilizer.

16. The regneration solution of claim 15 wherein the zincate stabilizer is selected from the group consisting of a silicate salt, lithium hydroxide, sorbatol, sodium metaborate and combinations thereof.

17. The regeneration solution of claim 15 wherein the stabilizer comprises sodium silicate.

18. The regeneration solution of claim 14 further comprising zinc particles.

19. The regeneration solution of claim 14 wherein the zincate ions are present in a concentration from about 0.3M to about 5.2M.

20. The regeneration solution of claim 14 wherein the at least one non-zinc metal oxide or metal hydroxide is present in a concentration from about 100 ppm by weight to about 500 ppm by weight.

21. The regeneration solution of claim 14 wherein the at least one non-zinc metal oxide or metal hydroxide is present in a concentration from about 50 ppm by weight to about 1000 ppm by weight.

22. The regeneration solution of claim 14 wherein the at least one non-zinc metal oxide is selected from the group consisting of the oxides of mercury, indium, bismuth, tin, lead, thallium and combinations thereof.

23. The regeneration solution of claim 14 wherein the sodium silicate is present in a concentration from about 1 percent by weight to about 5 percent by weight.

24. The regeneration solution of claim 14 further comprising poly(vinyl pyrrolidone) at a concentration from about 500 ppm to about 1000 ppm.

25. The regeneration solution of claim 14 wherein the electrolyte comprises potassium hydroxide at a concentration form about 30 weight percent to about 50 weight percent.

26. A regeneration unit comprising the regeneration solution of claim 14, an anode and a cathode suitable for regenerating metal particles.

27. The regeneration unit of claim 26 further comprising a pump for circulating a regeneration solution through the regeneration unit.

28. The regeneration unit of claim 26 further comprising a storage container for storing a portion of the regenerated collection of metal particles.

29. A method of replenishing the fuel for a metal-based fuel cell comprising an anode and a cathode, the method comprising:
providing a collection of particles of claim 14 dispersed in an electrolyte to the anode of the fuel cell.

30. The method of claim 29 wherein the collection of particles is generated in a regeneration unit comprising two electrodes.

31. The method of claim 29 wherein the collection of particles has a size distribution wherein at least 95 percent of the particles have a diameter greater than about 40 percent of the average diameter and less than about 160 percent of the average diameter.

32. A method for electrolytically generating zinc particles from a solution comprising oxidized zinc, the method comprising:
generating zinc particles from a regeneration solution by applying a sufficient voltage to the regeneration solution such that oxidized zinc is reduced to zinc particles, wherein the regeneration solution comprises an electrolyte, oxidized zinc, and at least one non-zinc metal oxide.

33. The method of claim 32 wherein the generated zinc particles have an average particle diameter from about 0.1 mm to about 1 mm.

34. The method of claim 32 wherein the regeneration solution further comprises sodium silicate.

35. The method of claim 32 wherein the voltage is applied to the regeneration solution in a regeneration unit using oppositely charged plates.

36. The method of claim 35 wherein the oppositely charged plates are aligned parallel to each other in the regeneration unit.

37. The method of claim 32 wherein the regeneration solution is continuously circulated through the regeneration unit by a pump.

38. The method of claim 32 wherein the regeneration solution is periodically circulated through the regeneration unit by a pump.

39. The method of claim 32 wherein at least a portion of the generated zinc particles are transported from the regeneration unit to a storage container.

40. The method of claim 32 wherein the generated zinc particles have a size distribution wherein at least 95 percent of the particles have a diameter greater than about percent of the average diameter and less than about 160 percent of the average diameter.

41. The method of claim 32 wherein the regeneration solution is generated in a metal/air fuel cell by the oxidation of a collection of particles comprising zinc and at least one non-zinc metal.

42. The method of claim 32 wherein the generated zinc particles are consumed in a metal/air fuel cell to form a consumed zinc solution.

43. The method of claim 42 wherein a sufficient voltage can be applied to the consumed zinc solution to generate a collection of zinc particles, wherein the collection of zinc particles has an average particle diameter from about 0.1 mm to about 1 mm.
